(19) United States
(12) Patent Application Publication
(10) Pub. No.: US 2019/0170243 A1
(43) Pub. Date: Jun. 6, 2019

(54) PASSIVE LUBRICANT MANAGEMENT SYSTEM

(71) Applicant: GM GLOBAL TECHNOLOGY OPERATIONS LLC, DETROIT, MI (US)

(72) Inventors: Chad R. Brizendine, Fenton, MI (US); David Schulz, Livonia, MI (US); Laurie B. Davenport, Livonia, MI (US); Mark A. Smakal, Byron, MI (US)

(21) Appl. No.: 15/831,951

(22) Filed: Dec. 5, 2017

(51) Int. Cl. F16H 57/04

(52) U.S. Cl. CPC F16H 57/0447; F16H 57/0409; F16H 57/0483; F16H 57/0434; F16H 57/0454

(57) ABSTRACT

An exemplary device for distributing gear lubricant in a gear assembly housing of a vehicle includes a gear assembly housing having a sealed interior portion defined by a first housing and an second housing, the sealed interior portion containing a lubricant and enclosing a gear assembly having a gear rotatably mounted in the gear assembly housing that rotates through the lubricant and a reservoir housing secured to an upper portion of the first housing, the reservoir housing defining a reservoir fluidly connected to the sealed interior portion of the gear assembly housing and including an orifice fluidly connected to a gear assembly component, the orifice having a predetermined size for allowing the lubricant to flow to the gear assembly component. As the gear rotates, the gear transfers the lubricant to the reservoir.

### INTRODUCTION

The present invention relates generally to the field of vehicles and, more specifically, to a passive oil management system within a gear housing.

Drive axles and transmissions have several gear sets that are often splash lubricated from an oil sump, or reservoir. As the gears turn in the lubricant, the gears and bearings are coated with the circulating lubricant. However, the lubricant in the reservoir imposes drag forces on the gears.

### SUMMARY

Embodiments according to the present disclosure provide a number of advantages. For example, embodiments according to the present disclosure enable lowering a sump level of lubricant within a gear assembly housing by storing lubricant transferred by the gears of the gear assembly housing in a separate reservoir. Additionally, lubricant from the reservoir may be distributed to various locations within the gear housing, such as, for example and without limitation, a clutch and one or more bearings.

The embodiments discussed herein illustrate a passive lubricant management system that delivers lubricant to contact bearings without flooding the bearings. Additionally, embodiments discussed herein further lower the level of lubricant within the sump by storing the lubricant in a top-mounted reservoir, reducing the amount of drag on the gears of the gear assembly.

In one aspect, a device for distributing gear lubricant in a gear assembly housing of a vehicle includes a gear assembly housing having a sealed interior portion defined by a first housing and an second housing, the sealed interior portion containing a lubricant and enclosing a gear assembly having a gear rotatably mounted in the gear assembly housing that rotates through the lubricant and a reservoir housing secured to an upper portion of the first housing, the reservoir housing defining a reservoir fluidly connected to the sealed interior portion of the gear assembly housing and including an orifice fluidly connected to a gear assembly component, the orifice having a predetermined size for allowing the lubricant to flow to the gear assembly component. As the gear rotates, the gear transfers the lubricant to the reservoir.

In some aspects, the gear assembly is a differential gear assembly.

In some aspects, the gear assembly is a transmission gear assembly.

In some aspects, the first housing defines a sump area that overlaps with at least a portion of the gear such that as the gear rotates through the sump area, the gear picks up lubricant and transfers the lubricant upward and outward within the first housing such that at least a portion of the lubricant is transferred to the reservoir housing.

In some aspects, the orifice is fluidly connected to a clutch of the gear assembly.

In some aspects, the orifice is fluidly connected to one or more bearings.

In some aspects, the housing further includes a passage fluidly connecting the orifice with a first bearing and a second bearing and a dividing member, the dividing member dividing a flow of the lubricant through the passage such that a portion of the lubricant flows to the first bearing and a portion of the lubricant flows to the second bearing.

In some aspects, the second housing is separately formed from the first housing and the reservoir housing is separately formed from the first housing and the second housing.

In some aspects, the second housing directs the lubricant into the reservoir housing.

In another aspect, a device for distributing gear lubricant in a gear assembly housing of a vehicle includes a gear assembly housing having a sealed interior portion containing a lubricant disposed in a first area and enclosing a gear assembly having a gear rotatably mounted in the gear assembly housing that rotates through the lubricant and a reservoir housing secured to an upper portion of the gear assembly housing, the reservoir housing defining a second area fluidly connected to the sealed interior portion of the gear assembly housing and including an orifice fluidly connected to a gear assembly component, the orifice having a predetermined size for allowing the lubricant to flow to the gear assembly component. As the gear rotates, the gear transfers lubricant from the first area to the second area.

In some aspects, the gear assembly is a differential gear assembly.

In some aspects, the gear assembly is a transmission gear assembly.

In some aspects, the gear assembly housing defines a sump area that overlaps with at least a portion of the gear such that as the gear rotates through the sump area, the gear picks up lubricant and transfers the lubricant upward and outward within the sealed interior portion such that at least a portion of the lubricant is transferred to the reservoir housing.

In some aspects, the orifice is fluidly connected to a clutch of the gear assembly.

In some aspects, the orifice is fluidly connected to one or more bearings.

In some aspects, the housing further includes a passage fluidly connecting the orifice with a first bearing and a second bearing and a dividing member, the dividing member dividing a flow of the lubricant through the passage such that a portion of the lubricant flows to the first bearing and a portion of the lubricant flows to the second bearing.

In some aspects, the device further includes a cover member separately formed from the gear assembly housing and the reservoir housing, the cover member configured to direct the lubricant into the reservoir housing.

### BRIEF DESCRIPTION OF THE DRAWINGS

The present disclosure will be described in conjunction with the following figures, wherein like numerals denote like elements.

FIG. 1 is a schematic cross-sectional diagram of a gear housing, according to an embodiment.

FIG. 2 is another schematic, cross-sectional diagram of the gear housing of FIG. 1.

FIG. 3 is a schematic, partial cross-sectional diagram of the gear housing of FIG. 1.

FIG. 4A is a schematic, partial cross-sectional diagram of the gear housing of FIG.1 illustrating the distribution of oil from a reservoir, according to an embodiment.

FIG. 4B is another schematic, partial cross-sectional diagram of the gear housing of FIG. 1 illustrating the distribution of oil from a reservoir, according to an embodiment.

FIG. 5 is a schematic, partial cross-sectional diagram of the gear housing of FIG. 1 illustrating a dividing member, according to an embodiment.

FIG. 6 is a schematic, partially-exploded cross-sectional diagram of the gear housing of FIG. 1.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

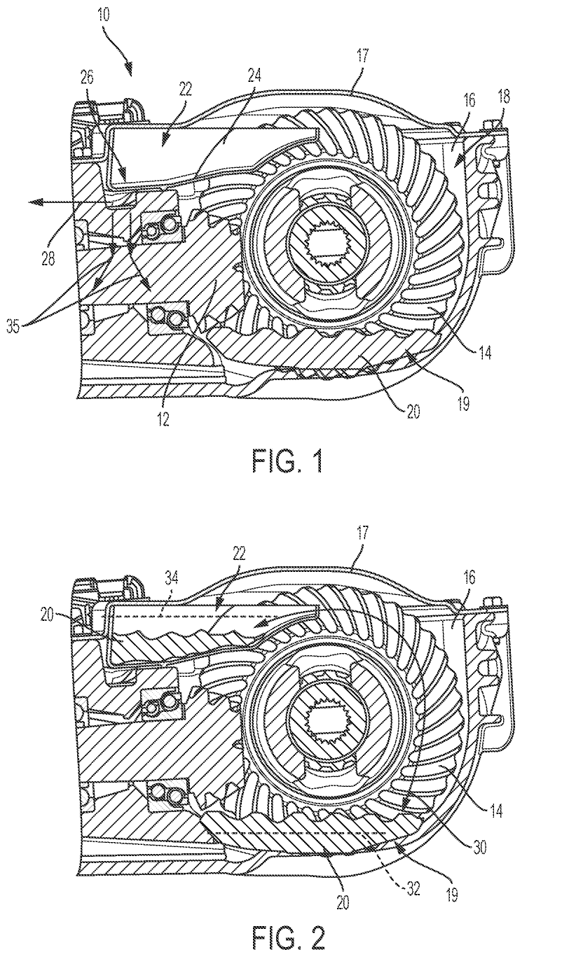

Referring now to FIG. 1, a gear assembly for an axle is enclosed within a differential gear assembly housing 10. The gear assembly, which in some embodiments is a gear set containing a pinion and a ring gear, terminates in a hypoid or beveled gear 12 having gear teeth that mate with complementarily configured gear teeth on a ring gear 14. In some embodiments, the gear assembly is a transmission gear assembly. In some embodiments, the gear assembly is a differential gear assembly.

A contoured, semi-circular first housing 16 preferably extends circumferentially approximately 180 degrees and, together with a contoured, semi-circular second housing 17, creates a sealed interior 18 defining a sump area 19. The sump area 19 contains a suitable weight oil or gear lubricant 20 that properly lubricates the engaging teeth of the gears 12, 14 as they rotate. The oil or gear lubricant 20 is preferably SAE 80 or 90 weight oil but may be much lighter such as SAE 30 or 40 weight depending upon the type of gears, ambient and operating temperatures and other operating considerations.

With reference to FIGS. 1 and 2, the ring gear 14 picks up lubricant 20 with the gear teeth and slings the lubricant 20 upward and outward as it rotates, as indicated by arrow 30. This “free” energy is then captured by diverting, deflecting and storing the lubricant 20 in a reservoir 22.

The reservoir 22 is defined by a reservoir housing 24 and the second housing 17. In some embodiments, the second housing 17 is a cover member configured to direct and contain fluid transferred to the reservoir housing 24. The reservoir housing 24 is, in some embodiments, formed separately from the first housing 16 and is coupled to an upper portion of the first housing using any type of mechanical fastener. The lubricant 20 collects within the reservoir 22 as the gears 12, 14 rotate. Openings 26 in the reservoir housing 24 allow the lubricant 20 to leave the reservoir 22 and flow to other components of a vehicle driveline assembly, such as to a clutch (indicated by arrow 28) or to one or more bearings (indicated by arrows 35). The lubricant 20 flow rate is preferably greater coming in to the reservoir 22 than the flow rate of lubricant 20 exiting the reservoir 22. As the reservoir fills, the level of lubricant 20 within the sump area 19 lowers by the corresponding volume. This in turn decreases drag on the gears 12, 14.

With continued reference to FIG. 2, during operation of the gear assembly, the reservoir 22 preferably remains full of lubricant 20. When operation of the gear assembly ceases, such as upon parking or stopping the vehicle, the lubricant 20 drains back into the sump area 19. If the reservoir 22 reaches capacity, as indicated by line 34, the oversupply of lubricant 20 can be distributed through a “blow off” channel 25 (see FIG. 6). In some embodiments, as discussed in greater detail herein, lubricant 20 is delivered to other components, such as a clutch or one or more bearings, via the blow off channel 25. A minimum level of lubricant 20 within the sump area 19 is indicated by arrow 32.

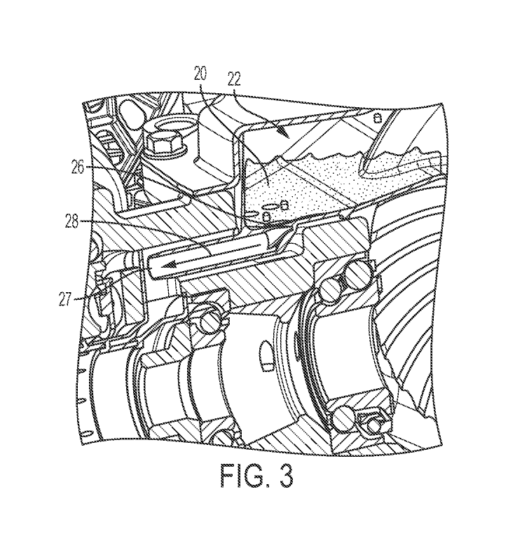

As shown in FIG. 3, in some embodiments, at least a portion of the lubricant 20 is directed through one or more openings 26 and, via one or more passages, such as passage 27, is delivered to one or more components of the gear assembly, such as a clutch, as indicated by arrow 28.

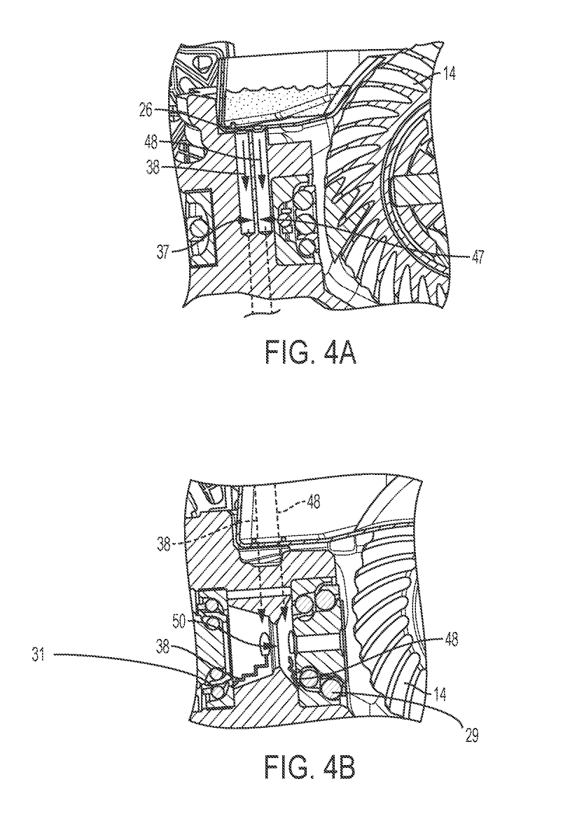

Additionally, in some embodiments, at least a portion of the lubricant 20 is directed through the one or more openings 26 and, via one or more passages, such as the passages 37, 47, is delivered to one or more components of the gear assembly, such as a head bearing and/or a tail bearing, as indicated by the arrows 38, 48, as shown in FIGS. 4A and 4B.

In some embodiments, the lubricant 20 is throttled to a desired flow rate for delivery to the clutch and/or the bearings. In some embodiments, metering of the lubricant 20 is accomplished by one or more valves, such as a variable valve (not shown) located, for example, at the openings 26. However, control of the flow rate of the lubricant 20 to the clutch and/or the bearings may be accomplished by any means known to those skilled in the art, such as, for example and without limitation, the diameter of the passages 27, 37, 47 or the diameter of the one or more openings 26.

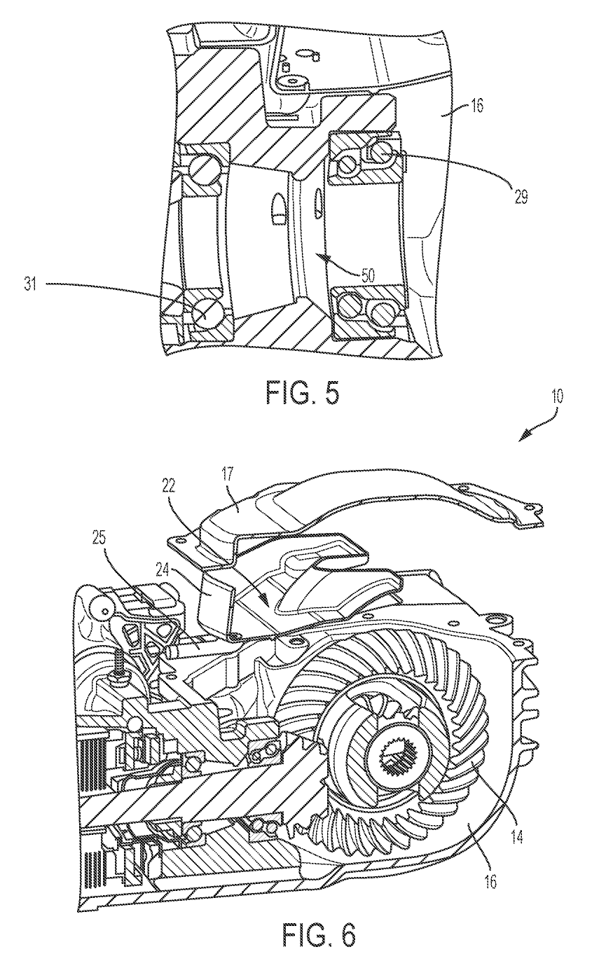

In some embodiments, with reference to FIGS. 4B and 5, the first housing 16 includes a dividing member 50. The dividing member 50 is, in some embodiments, integrally formed with the first housing 16. The dividing member 50 separates or splits the flow of the lubricant 20 to two sets of bearings, such as head 29 and tail 31 bearings. In some embodiments, distribution of lubricant 20 to the head and/or tail bearings is accomplished independently to ensure both sets of bearings receive a constant supply of lubricant 20.

With reference to FIG. 6, the first housing 16 surrounds the ring gear 14 to capture the lubricant 20 as it is transferred from the sump area 19 to the reservoir 22. The second housing 17 is conformed to direct the lubricant 20 into the reservoir 22. In some embodiments, the second housing 17 is a separate component from the first housing 16. In some embodiments, the reservoir housing 24 is a separate component from the first housing 16 and from the second housing 17. In some embodiments, the reservoir housing 24 straddles the gear 14 such that lubricant 20 enters the reservoir housing 24 from either side of the gear 14. The “top load” reservoir configuration shown in FIGS. 1-6 enables efficient and cost-effective integration of the reservoir housing 24 with the gear assembly housing 10 and further enables storage and distribution of the lubricant 20 to additional components of the gear assembly.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term. “substantially” means that the recited characteristic parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term. “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A device for distributing gear lubricant in a gear assembly housing of a vehicle, comprising:
a gear assembly housing having a sealed interior portion defined by a first housing and a second housing, the sealed interior portion containing a lubricant and enclosing a gear assembly having a gear rotatably mounted in the gear assembly housing that rotates through the lubricant; and
a reservoir housing secured to an upper portion of the first housing, the reservoir housing defining a reservoir fluidly connected to the sealed interior portion of the gear assembly housing and including an orifice fluidly connected to a gear assembly component, the orifice having a predetermined size for allowing the lubricant to flow to the gear assembly component;
wherein as the gear rotates, the gear transfers the lubricant to the reservoir.

2. The device of claim 1, wherein the gear assembly is a differential gear assembly.

3. The device of claim 1, wherein the gear assembly is a transmission gear assembly.

4. The device of claim 1, wherein the first housing defines a sump area that overlaps with at least a portion of the gear such that as the gear rotates through the sump area, the gear picks up lubricant and transfers the lubricant upward and outward within the first housing such that at least a portion of the lubricant is transferred to the reservoir housing.

5. The device of claim 1, wherein the orifice is fluidly connected to a clutch of the gear assembly.

6. The device of claim 1, wherein the orifice is fluidly connected to one or more bearings.

7. The device of claim 6, wherein the housing further comprises a passage fluidly connecting the orifice with a first bearing and a second bearing and a dividing member, the dividing member dividing a flow of the lubricant through the passage such that a portion of the lubricant flows to the first bearing and a portion of the lubricant flows to the second bearing.

8. The device of claim 1, wherein the second housing is separately formed from the first housing and the reservoir housing is separately formed from the first housing and the second housing.

9. The device of claim 8, wherein the second housing directs the lubricant into the reservoir housing.

10. A device for distributing gear lubricant in a gear assembly housing of a vehicle, comprising:
a gear assembly housing having a sealed interior portion containing a lubricant disposed in a first area and enclosing a gear assembly having a gear rotatably mounted in the gear assembly housing that rotates through the lubricant; and
a reservoir housing secured to an upper portion of the gear assembly housing, the reservoir housing defining a second area fluidly connected to the sealed interior portion of the gear assembly housing and including an orifice fluidly connected to a gear assembly component, the orifice having a predetermined size for allowing the lubricant to flow to the gear assembly component;
wherein as the gear rotates, the gear transfers lubricant from the first area to the second area.

11. The device of claim 10, wherein the gear assembly is a differential gear assembly.

12. The device of claim 10, wherein the gear assembly is a transmission gear assembly.

13. The device of claim 10, wherein the gear assembly housing defines a sump area that overlaps with at least a portion of the gear such that as the gear rotates through the sump area, the gear picks up lubricant and transfers the lubricant upward and outward within the sealed interior portion such that at least a portion of the lubricant is transferred to the reservoir housing.

14. The device of claim 10, wherein the orifice is fluidly connected to a clutch of the gear assembly.

15. The device of claim 10, wherein the orifice is fluidly connected to one or more bearings.

16. The device of claim 15, wherein the housing further comprises a passage fluidly connecting the orifice with a first bearing and a second bearing and a dividing member, the dividing member dividing a flow of the lubricant through the passage such that a portion of the lubricant flows to the first bearing and a portion of the lubricant flows to the second bearing.

17. The device of claim 10, further comprising a cover member separately formed from the gear assembly housing and the reservoir housing, the cover member configured to direct the lubricant into the reservoir housing.
